(19) United States
(12) Patent Application Publication
(10) Pub. No.: US 2021/0201824 A1
(43) Pub. Date: Jul. 1, 2021

(54) PIXEL CIRCUIT

(71) Applicants: Interface Technology (ChengDu) Co., Ltd., Sichuan (CN); Interface Optoelectronics (ShenZhen) Co., Ltd., Guangdong (CN); General Interface Solution Limited, Miaoli County (TW)

(72) Inventors: Chung-Chun CHEN, Guangdong (CN); Ya-Chu YANG, Guangdong (CN); Yen-Chieh HUANG, Guangdong (CN); Sheng-Chun CHUANG, Guangdong (CN); Po-Lun CHEN, Guangdong (CN)

(21) Appl. No.: 16/830,229

(22) Filed: Mar. 25, 2020

(30) Foreign Application Priority Data
Dec. 26, 2019 (CN) 201911368799.9

(51) Int. Cl. G09G 3/3291; G09G 3/20

(52) U.S. Cl. CPC G09G 3/3291; G09G 2300/0439; G09G 2330/028; G09G 3/2003

(57) ABSTRACT

A pixel circuit includes at least one pixel. The at least one pixel includes a first light emitting diode, a second light emitting diode, and a third light emitting diode. A first terminal of the first light emitting diode is configured to receive a voltage signal. A second terminal of the first light emitting diode is configured to receive a first current signal. A first terminal of the second light emitting diode is configured to receive the voltage signal. A second terminal of the second light emitting diode is configured to receive a second current signal. A first terminal of the third light emitting diode is configured to receive the voltage signal. A second terminal of the third light emitting diode is configured to receive a third current signal.

### RELATED APPLICATIONS

This application claims priority to Chinese Application Serial Number 201911368799.9, filed Dec. 26, 2019, which is herein incorporated by reference.

### BACKGROUND

### Technical Field

The present disclosure relates to a pixel circuit. More particularly, the present disclosure relates to a pixel circuit having a simpler structure.

### Description of Related Art

With developments of display technology, display devices are applied to various electrical apparatus. In some related approaches, a plurality of pixel regions are arranged with an array form on a micro light emitting diode (LED) display device. Each of the pixel regions includes a plurality of sub-pixels. Each of the sub-pixels has a micro light emitting diode. By outputting a driving signal from a driving circuit to each micro light emitting diode, the each micro light emitting diode is controlled to be turned on or turned off. With operation of the micro light emitting diodes, a function of displaying different images by the micro light emitting diode display device is achieved.

However, in some related approaches, the driving circuit of the display device has a high complexity, the pixel array and the light emitting elements are not combined well, and it is hard to control the display device very well.

### SUMMARY

Some aspects of the present disclosure are to provide a pixel circuit. The pixel circuit includes at least one pixel. The at least one pixel includes a first light emitting diode, a second light emitting diode, and a third light emitting diode. The first light emitting diode includes a first terminal and a second terminal. A first terminal of the first light emitting diode is configured to receive a voltage signal, and a second terminal of the first light emitting diode is configured to receive a first current signal. An illumination of the first light emitting diode is determined based on the voltage signal and the first current signal. The second light emitting diode includes a first terminal and a second terminal. A first terminal of the second light emitting diode is configured to receive the voltage signal, and a second terminal of the second light emitting diode is configured to receive a second current signal. An illumination of the second light emitting diode is determined based on the voltage signal and the second current signal. The third light emitting diode includes a first terminal and a second terminal. A first terminal of the third light emitting diode is configured to receive the voltage signal, and a second terminal of the third light emitting diode is configured to receive a third current signal. An illumination of the third light emitting diode is determined based on the voltage signal and the third current signal.

Some aspects of the present disclosure are to provide a pixel circuit. The pixel circuit includes a first pixel, a first driving circuit, and a second driving circuit. The first pixel includes a first light emitting diode, a second light emitting diode, and a third light emitting diode. Each of the first light emitting diode, the second light emitting diode, and the third light emitting diode includes a first terminal and a second terminal. The first driving circuit is coupled to the first terminal of the first light emitting diode, the first terminal of the second light emitting diode, and the first terminal of the third light emitting diode via at least one first line. The second driving circuit is coupled to the second terminal of the first light emitting diode via a second line, coupled to the second terminal of the second light emitting diode via a third line, and coupled to the second terminal of the third light emitting diode via a fourth line.

Some aspects of the present disclosure are to provide a pixel circuit. The pixel circuit includes at least one pixel. The at least one pixel includes a first light emitting diode. The first light emitting diode includes a first terminal and a second terminal and is corresponding to a first voltage threshold value. The first driving circuit is configured to output a voltage signal to the first terminal of the first light emitting diode. The second driving circuit is configured to output a first current signal to the second terminal of the first light emitting diode. In response to the voltage signal and the first current signal, a first voltage difference is established across the first terminal of the first light emitting diode and the second terminal of the first light emitting diode. The first voltage different and the first voltage threshold value are configured to determine an illumination of the first light emitting diode.

As described above, the pixel circuit of the present disclosure has a simpler structure.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a pixel circuit according to some embodiments of the present disclosure.

FIG. 2A is a schematic diagram of one row of pixels in FIG. 1.

FIG. 2B is a schematic diagram of a pixel in FIG. 1 according to some other embodiments of the present disclosure.

FIG. 3 is a schematic diagram of a pixel circuit according to some embodiments of the present disclosure.

FIG. 4 is a schematic diagram of a pixel in FIG. 3 according to some other embodiments of the present disclosure.

FIG. 5 is a waveform diagram of a plurality of signals according to some embodiments of the present disclosure.

FIG. 6 is a schematic diagram of one row of pixels in FIG. 1 according to some other embodiments of the present disclosure.

FIG. 7 is a waveform diagram of a plurality of signals according to some other embodiments of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present disclosure. That is, these details of practice are not necessary in part of embodiments of the present embodiments. Furthermore, for simplifying the drawings, some of the conventional structures and elements are shown with schematic illustrations.

In the present disclosure, “connected” or “coupled” may refer to “electrically connected” or “electrically coupled.” “Connected” or “coupled” may also refer to operations or actions between two or more elements.

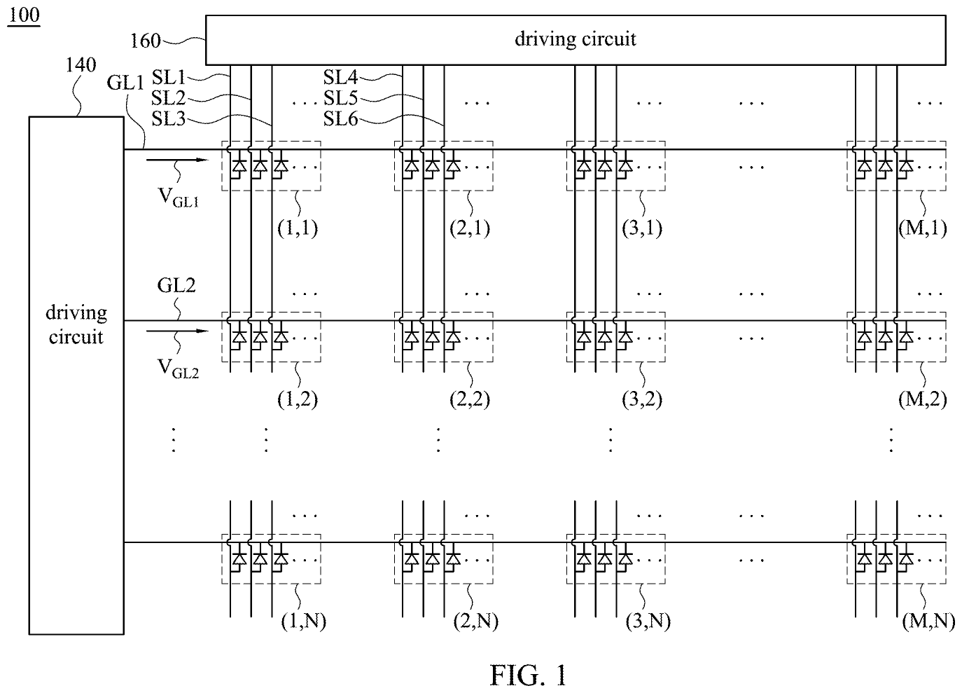

Reference is made to FIG. 1. FIG. 1 is a schematic diagram of a pixel circuit 100 according to some embodiments of the present disclosure. In some embodiments, the pixel circuit 100 is applied to a display panel. As illustrated in FIG. 1, the pixel circuit 100 includes a plurality of pixels (1,1)-(M,N), a driving circuit 140 and a driving circuit 160. The pixels (1,1)-(M,N) includes M columns and N rows, in which M and N are positive integers. The driving circuit 140 is coupled to the pixels (1,1)-(M,N). The driving circuit 160 is coupled to the pixels (1,1)-(M,N). The driving circuit 140 works in coordination with the driving circuit 160 to control the pixels (1,1)-(M,N).

It is noted that various quantities of the pixels are within the scope of the present disclosure. In addition, in some other embodiments, the driving circuit 140 and the driving circuit 160 are integrated to be a single driving circuit.

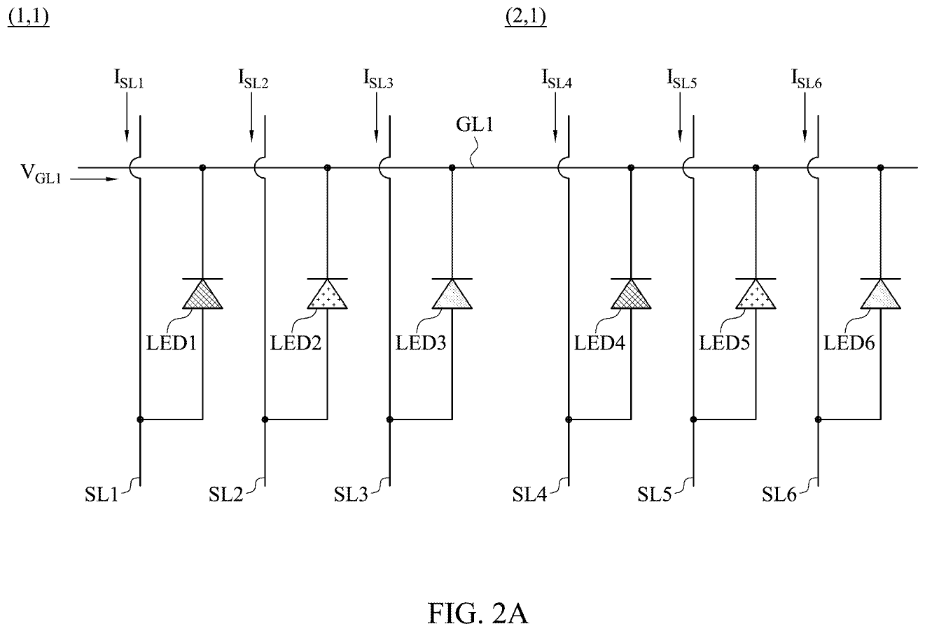

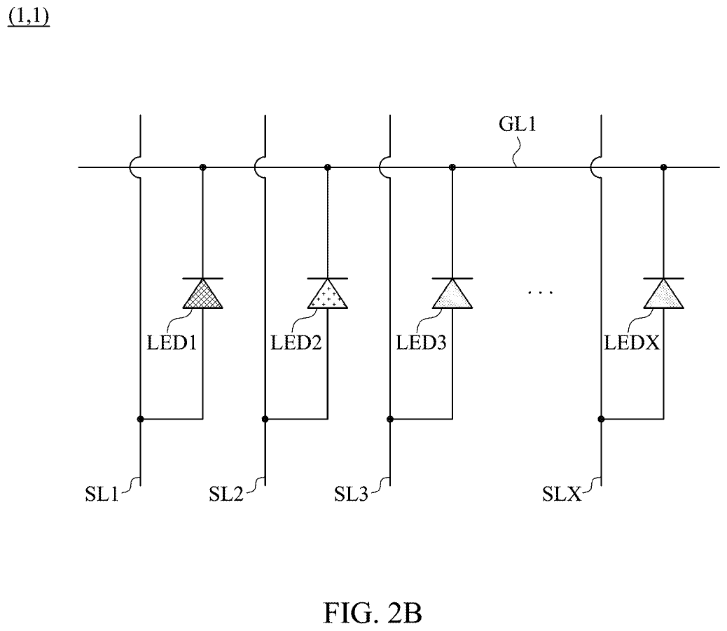

FIG. 2A is a schematic diagram of one row of pixels in FIG. 1. For simplicity to facilitate understanding, FIG. 2A merely illustrates two pixels (1,1) and (2,1) of the first row, and other pixels are omitted.

Reference is made to FIG. 2A. The pixel (1,1) includes a light emitting diode LED1, a light emitting diode LED2, and a light emitting diode LED3. The pixel (2,1) includes a light emitting diode LED4, a light emitting diode LED5, and a light emitting diode LED6. In this embodiment, the light emitting diode LED1 and the light emitting diode LED4 are red light emitting diodes, the light emitting diode LED2 and the light emitting diode LED5 are green light emitting diodes, and the light emitting diode LED3 and the light emitting diode LED6 are blue light emitting diodes, but the present disclosure is not limited thereto. In some embodiments, the light emitting diode LED1, the light emitting diode LED2, the light emitting diode LED3, the light emitting diode LED4, the light emitting diode LED5, and the light emitting diode LED6 are micro light emitting diodes, but the present disclosure is not limited thereto.

Each of the light emitting diode LED1, the light emitting diode LED2, the light emitting diode LED3, the light emitting diode LED4, the light emitting diode LED5, and the light emitting diode LED6 includes a first terminal and a second terminal. The first terminal is, for example, a cathode terminal, and the second terminal is, for example, an anode terminal, but the present disclosure is not limited thereto.

The driving circuit 140 is coupled to pixels of the first row via a line GL1. References are made to FIG. 1 and FIG. 2A. The driving circuit 140 is coupled to the first terminal of the light emitting diode LED1, the first terminal of the light emitting diode LED2, the first terminal of the light emitting diode LED3, the first terminal of the light emitting diode LED4, the first terminal of the light emitting diode LED5, and the first terminal of the light emitting diode LED6 via the line GL1.

The driving circuit 140 sends a voltage signal V_{GL1} to the first terminal of the light emitting diode LED1, the first terminal of the light emitting diode LED2, the first terminal of the light emitting diode LED3, the first terminal of the light emitting diode LED4, the first terminal of the light emitting diode LED5, and the first terminal of the light emitting diode LED6 via the line GL1.

Reference is made to FIG. 1 again. The driving circuit 140 is coupled to pixels of the second row via a line GL2. As illustrated in FIG. 1, the driving circuit 140 is coupled to first terminals of light emitting diodes of the second row via the line GL2, to send a voltage signal V_{GL2} to the first terminals of the light emitting diodes of a pixel (1,2). Other parts of the pixel circuit 100 have similar structures, so they are not described herein again.

Based on above, in this example, the light emitting diodes of a same row are coupled to the driving circuit 140 via a same line. The light emitting diodes of different rows are coupled to the driving circuit 140 via different lines.

The driving circuit 160 is coupled to the second terminal of the light emitting diode LED1 via a line SL1. The driving circuit 160 sends a current signal I_{SL1} to the second terminal of the light emitting diode LED1 via the line SL1. The driving circuit 160 is coupled to the second terminal of the light emitting diode LED2 via a line SL2. The driving circuit 160 sends a current signal I_{SL2} to the second terminal of the light emitting diode LED2 via the line SL2. The driving circuit 160 is coupled to the second terminal of the light emitting diode LED3 via a line SL3. The driving circuit 160 sends a current signal I_{SL3} to the second terminal of the light emitting diode LED3 via the line SL3.

The driving circuit 160 is coupled to the second terminal of the light emitting diode LED4 via a line SL4. The driving circuit 160 sends a current signal I_{SL4} to the second terminal of the light emitting diode LED4 via the line SL4. The driving circuit 160 is coupled to the second terminal of the light emitting diode LED5 via a line SL5. The driving circuit 160 sends a current signal I_{SL5} to the second terminal of the light emitting diode LED5 via the line SL5. The driving circuit 160 is coupled to the second terminal of the light emitting diode LED6 via a line SL6. The driving circuit 160 sends a current signal I_{SL6} to the second terminal of the light emitting diode LED6 via the line SL6.

Based on above, in this example, the light emitting diodes of a same column are coupled to the driving circuit 160 via a same line. The light emitting diodes having different color light of a same column are coupled to the driving circuit 160 via different lines.

An illumination of the light emitting diode LED1 is determined based on the current signal I_{SL1} and the voltage signal V_{GL1}. Specifically, based on a voltage generated at the second terminal of the light emitting diode LED1 due to the current signal I_{SL1} and the voltage signal V_{GL1} at the first terminal of the light emitting diode LED1, a voltage difference is formed across the two terminals of the light emitting diode LED1. Based on an element characteristic of the light emitting diode LED1, the light emitting diode LED1 is corresponding to and has a build-in voltage threshold value (for example, 2.0 volts). This voltage threshold value and the voltage difference across the two terminals of the light emitting diode LED1 can be configured to determine the illumination of the light emitting diode LED1.

Similarly, an illumination of the light emitting diode LED2 is determined based on the current signal I_{SL2} and the voltage signal V_{GL1}. Specifically, based on a voltage generated at the second terminal of the light emitting diode LED2 due to the current signal I_{SL2} and the voltage signal V_{GL1} at the first terminal of the light emitting diode LED2, a voltage difference is formed across the two terminals of the light emitting diode LED2. Based on an element characteristic of the light emitting diode LED2, the light emitting diode LED2 is corresponding to and has a build-in voltage threshold value (for example, 1.9-4.0 volts). This voltage threshold value and the voltage difference across the two terminals of the light emitting diode LED2 can be configured to determine the illumination of the light emitting diode LED2.

Similarly, an illumination of the light emitting diode LED3 is determined based on the current signal I_{SL3} and the voltage signal V_{GL1}. Specifically, based on a voltage generated at the second terminal of the light emitting diode LED3 due to the current signal I_{SL3} and the voltage signal V_{GL1} at the first terminal of the light emitting diode LED3, a voltage difference is formed across the two terminals of the light emitting diode LED3. Based on an element characteristic of the light emitting diode LED3, the light emitting diode LED3 is corresponding to and has a build-in voltage threshold value (for example, 2.5-3.5 volts). This voltage threshold value and the voltage difference across the two terminals of the light emitting diode LED3 can be configured to determine the illumination of the light emitting diode LED3.

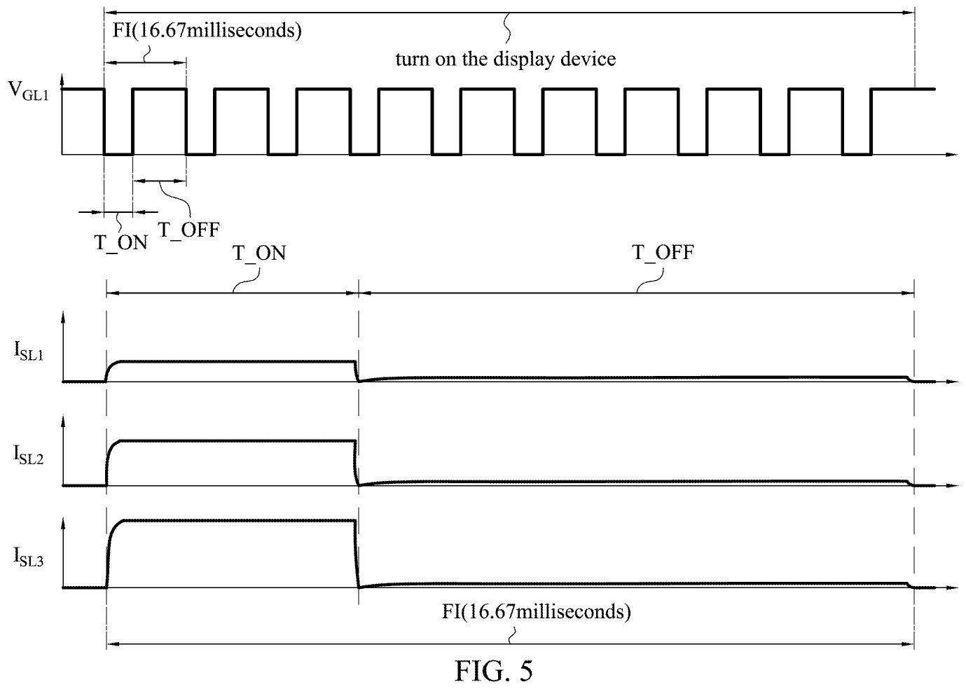

How to determine the illumination of each of the light emitting diodes based on the voltage threshold value and the voltage across the two terminals of the each of the light emitting diodes is described in detail in following paragraphs with FIG. 5.

In some embodiments, the build-in voltage threshold value of the light emitting diode LED1, the build-in voltage threshold value of the light emitting diode LED2, and the build-in voltage threshold value of the light emitting diode LED3 are different from each other. The values of the voltage threshold values disclosed above are for illustration, and other suitable values are within the scope of the present disclosure.

References are made to FIG. 1 and FIG. 2B. FIG. 2B is a schematic diagram of the pixel (1,1) in FIG. 1 according to some other embodiments of the present disclosure. In these embodiments, each pixel may have more than 3 light emitting diodes. As illustrated in FIG. 2B, the pixel (1,1) has X light emitting diodes (for example, light emitting diodes LED1-LEDX). Similar to FIG. 1, the light emitting diodes LED1-LEDX of the pixel (1,1) in FIG. 2B are coupled to the driving circuit 160 via different lines. For example, the light emitting diode LED1 is coupled to the driving circuit 160 via the line SL1, the light emitting diode LED2 is coupled to the driving circuit 160 via the line SL2, the light emitting diode LED3 is coupled to the driving circuit 160 via the line SL3, and the light emitting diode LEDX is coupled to the driving circuit 160 via a line SLX.

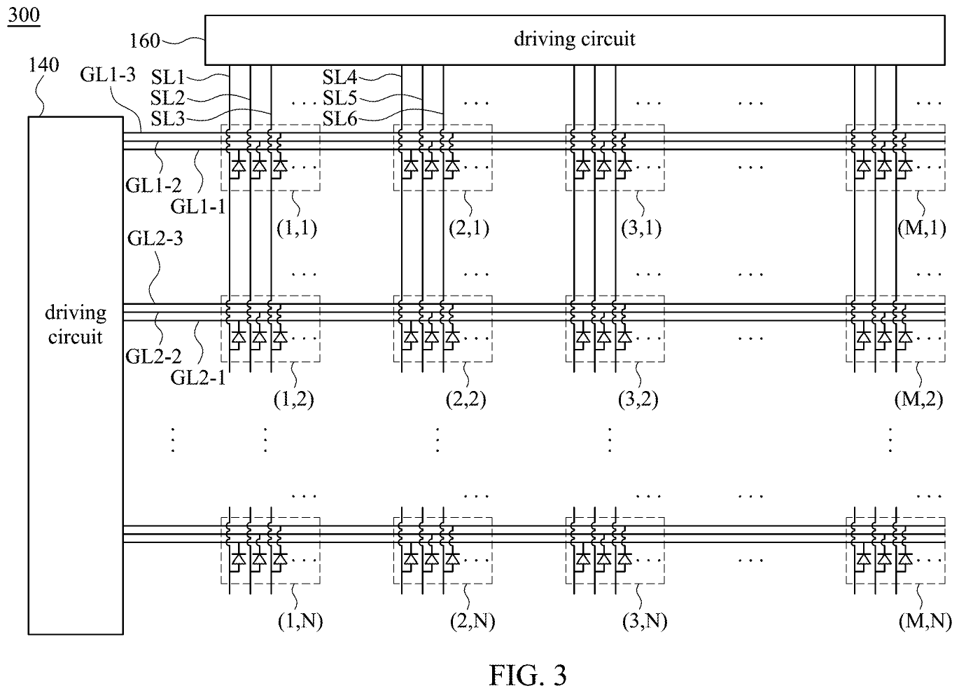

Reference is made to FIG. 3. FIG. 3 is a schematic diagram of a pixel circuit 300 according to some embodiments of the present disclosure. In some embodiments, the pixel circuit 300 is applied to a display panel. The pixel circuit 300 in FIG. 3 is similar to the pixel circuit 100 in FIG. 1. A main difference between the pixel circuit 300 in FIG. 3 and the pixel circuit 100 in FIG. 1 is that three light emitting diodes of each of the pixels of a same row of the pixel circuit 300 are coupled to the driving circuit 140 via different lines, and the light emitting diodes having a same color light of the pixels of the same row are coupled to the driving circuit 140 via a same line.

As illustrated in FIG. 3, the three light emitting diodes of each of the pixels of the first row are coupled to the driving circuit 140 via a line GL1-1, a line GL1-2, and a line GL1-3 respectively. The three light emitting diodes of each of the pixels of the second row are coupled to the driving circuit 140 via a line GL2-1, a line GL2-2, and a line GL2-3 respectively. Other parts of the pixel circuit 300 have similar structures, so they are not described herein again.

In addition, operation principles of the pixel circuit 300 are similar to the operation principles of the pixel circuit 100, so the operation principles of the pixel circuit 300 are not described herein again.

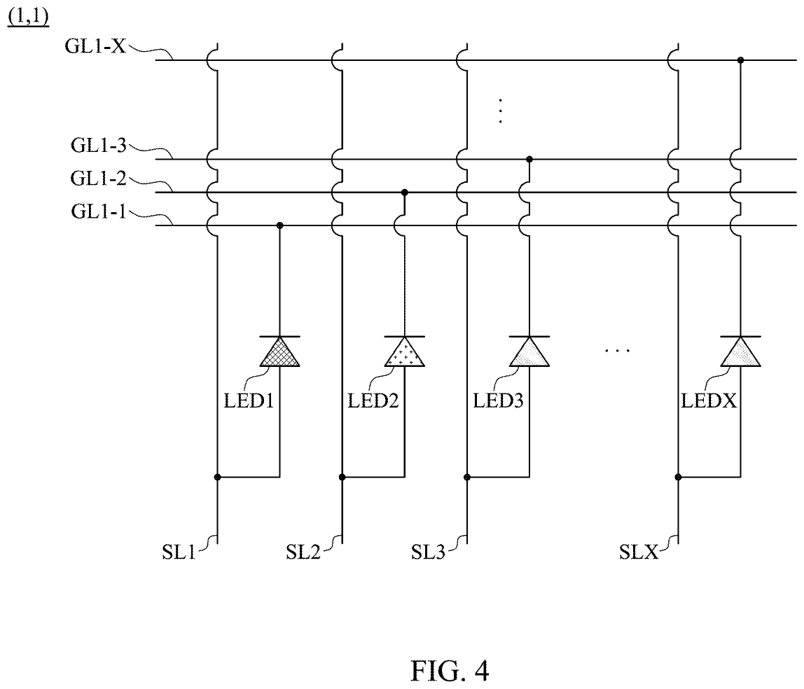

References are made to FIG. 3 and FIG. 4. FIG. 4 is a schematic diagram of a pixel (1, 1) in FIG. 3 according to some other embodiments of the present disclosure. In these embodiments, each of the pixels may have more than three light emitting diodes. For illustrated in FIG. 4, the pixel (1,1) includes X light emitting diodes (For example, light emitting diodes LED1-LEDX). Similar to FIG. 3, each of the light emitting diodes of the pixel (1,1) in FIG. 4 are coupled to the driving circuit 140 via different lines. For example, the light emitting diode LED1 is coupled to the driving circuit 140 via the line GL1-1, the light emitting diode LED2 is coupled to the driving circuit 140 via the line GL1-2, the light emitting diode LED3 is coupled to the driving circuit 140 via the line GL1-3, and the light emitting diode LEDX is coupled to the driving circuit 140 via a line GL1-X.

Reference is made to FIG. 5. FIG. 5 is a waveform diagram of a plurality of signals according to some embodiments of the present disclosure. The pixel (1,1) in FIG. 2A is taken as an example in FIG. 5, so only waveforms of the voltage signal V_{GL1}, the current signal I_{SL1} the current signal I_{SL2}, and the current signal I_{SL3} are illustrated in FIG. 5.

For illustrated in FIG. 5, a frame interval FI includes a turned-on time duration T_ON and a turned-off time duration T_OFF. In some embodiments, the frame interval FI is substantially about 16.67 milliseconds. In other words, a display frequency of the display device is 60 Hz.

How to determine the illumination of each of the light emitting diodes based on the voltage threshold value and the voltage across the two terminals of the each of the light emitting diodes is described in detail in following paragraphs.

In the turned-on time duration T_ON, since the voltage signal V_{GL1} has a low voltage level and the current signal I_{SL1} is a large current, a voltage difference is formed across the two terminals of the light emitting diode LED1. If the voltage difference is greater than the build-in voltage threshold value of light emitting diode LED1, the light emitting diode LED1 shines (the illumination of the light emitting diode LED1 increases). Similarly, since the voltage signal V_{GL2} has a low voltage level and the current signal I_{SL2} is a large current, a voltage difference is formed across the two terminals of the light emitting diode LED2. If the voltage difference is greater than the build-in voltage threshold value of light emitting diode LED2, the light emitting diode LED2 shines (the illumination of the light emitting diode LED2 increases). Similarly, since the voltage signal V_{GL3} has a low voltage level and the current signal I_{SL3} is a large current, a voltage difference is formed across the two terminals of the light emitting diode LED3. If the voltage difference is greater than the build-in voltage threshold value of light emitting diode LED3, the light emitting diode LED3 shines (the illumination of the light emitting diode LED3 increases).

In some embodiments, a current value of the current signal I_{SL1}, a current value of the current signal I_{SL2}, and a current value of the current signal I_{SL3} are designed to be different from each other based on the build-in voltage threshold value of the light emitting diode LED1, the build-in voltage threshold value of the light emitting diode LED2, and the build-in voltage threshold value of the light emitting diode LED3. For example, the current value of the current signal I_{SL3} is greater than the current value of the current signal I_{SL2}, and the current value of the current signal I_{SL2} is greater than the current value of the current signal I_{SL1}.

In the turned-off time duration T_OFF, since the voltage signal V_{GL1} has a high voltage level and the current signal I_{SL1} is a small current, the voltage different across the two terminals of the light emitting diode LED1 is 0 volt or less than the build-in voltage threshold value of the light emitting diode LED1. Under this condition, the light emitting diode LED1 does not shines (the illumination of the light emitting diode LED1 decreases). Similarly, since the voltage signal V_{GL2} has a high voltage level and the current signal I_{SL2} is a small current, the voltage different across the two terminals of the light emitting diode LED2 is 0 volt or less than the build-in voltage threshold value of the light emitting diode LED2. Under this condition, the light emitting diode LED2 does not shines (the illumination of the light emitting diode LED2 decreases). Similarly, since the voltage signal V_{GL3} has a high voltage level and the current signal I_{SL3} is a small current, the voltage different across the two terminals of the light emitting diode LED3 is 0 volt or less than the build-in voltage threshold value of the light emitting diode LED3. Under this condition, the light emitting diode LED3 does not shines (the illumination of the light emitting diode LED3 decreases).

Based on above, the voltage differences can be configured to determine the illuminations of the light emitting diodes. However, an illumination change of a light emitting diode is associated with a current change of the light emitting diode. For example, an illumination change of the light emitting diode LED1 is associated with a current change of the light emitting diode LED1, an illumination change of the light emitting diode LED2 is associated with a current change of the light emitting diode LED2, and an illumination change of the light emitting diode LED3 is associated with a current change of the light emitting diode LED3.

Operation principles of the pixel (2,1) and other pixels are similar to the operation principles of the pixel (1,1), so they are not described herein again.

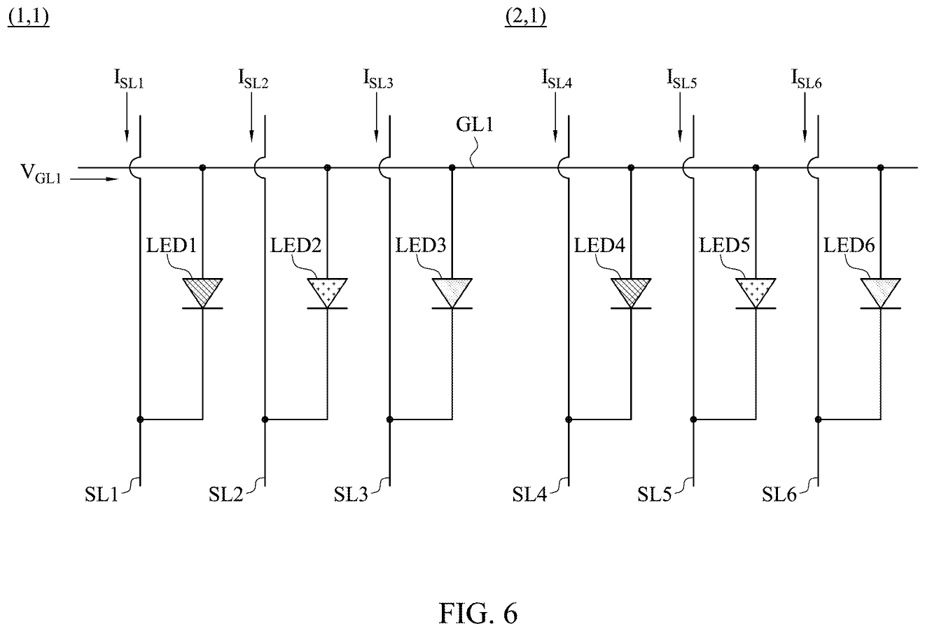

Reference is made to FIG. 6. FIG. 6 is a schematic diagram of one row of pixels in FIG. 1 according to some other embodiments of the present disclosure. A main difference between the pixels (1,1) and (2,1) in FIG. 6 and the pixel (1,1) and (2,1) in FIG. 2A is that, in the pixel (1,1) and (2,1) in FIG. 6, the light emitting diodes LED1-LED6 are disposed inversely. In other words, the cathodes of the light emitting diodes LED1-LED6 are coupled to the lines SL1-SL6 respectively, to receive the current signal I_{SL1}-I_{SL6} respectively. The anodes of the light emitting diodes LED1-LED6 are coupled to the line GL1, to receive the voltage signal V_{GL1}.

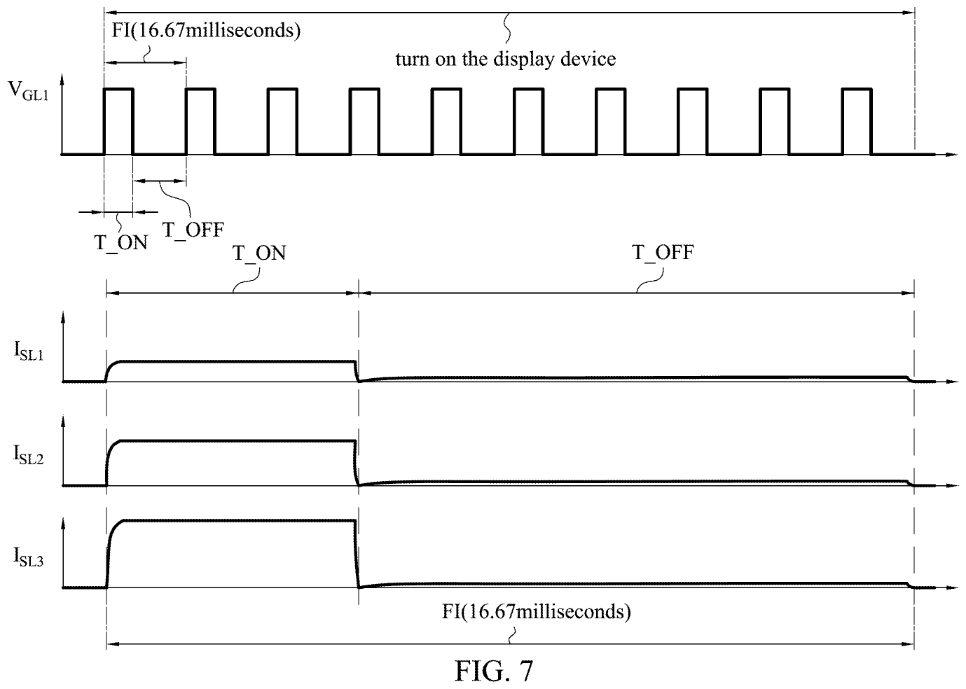

Reference is made to FIG. 7. FIG. 7 is a waveform diagram of a plurality of signals according to some other embodiments of the present disclosure. FIG. 7 illustrates waveforms of a plurality of signals in FIG. 6. Since the light emitting diodes LED1-LED6 in FIG. 6 are disposed inversely, a main difference between FIG. 7 and FIG. 5 is that, the turned-on time duration T_ON in FIG. 7 is a time duration when the voltage signal V_{GL1} has a high voltage level, and the turned-off time duration T_OFF is a time duration when the voltage signal V_{GL1} has a low voltage level. Operation principles in FIG. 7 are similar to the operation principles in FIG. 5, so they are not described herein again.

Based on above, each of the light emitting diodes of each of pixels of the pixel circuit 100 or 300 is driven according to merely two signals. For example, the light emitting diode LED1 is driven according to merely the voltage signal V_{GL1} and the current signal I_{SL1}. Compared to traditional technology using a large number of elements and signals to drive the light emitting diodes, the pixel circuit 100 or 300 of the present disclosure has a simpler structure. Accordingly, the pixel circuit 100 or 300 of the present disclosure has advantages of ease to produce and low cost, and can be applied to various display devices.

In addition, since the pixel circuit 100 or 300 of the present disclosure has a simpler structure, the pixel circuit 100 or 300 of the present disclosure has more spaces to dispose the light emitting diodes. Under this condition, it benefits a combination of the light emitting diodes and driving circuitries. Accordingly, the pixel circuit 100 or 300 of the present disclosure has advantages of ease to produce and low cost, and can be applied to various display devices.

Furthermore, compared to traditional technology using a large number of elements and signals to drive the light emitting diodes, illumination control methods of the pixel circuit 100 or 300 of the present disclosure are easier. Under this condition, it can avoid to use other complex methods to control the illuminations of the light emitting diodes or the illumination of the pixel circuit. Accordingly, the pixel circuit 100 or 300 of the present disclosure has advantages of ease to produce and low cost, and can be applied to various display devices.

As described above, the pixel circuit of the present disclosure has a simpler structure.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuity in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A pixel circuit, comprising:
at least one pixel comprising:
a first light emitting diode comprising a first terminal and a second terminal, wherein the first terminal of the first light emitting diode is configured to receive a voltage signal via a first sub-line, and the second terminal of the first light emitting diode is configured to receive a first current signal, wherein an illumination of the first light emitting diode is determined based on the voltage signal and the first current signal;
a second light emitting diode comprising a first terminal and a second terminal, wherein the first terminal of the second light emitting diode is configured to receive the voltage signal via a second sub-line, and the second terminal of the second light emitting diode is configured to receive a second current signal, wherein an illumination of the second light emitting diode is determined based on the voltage signal and the second current signal; and
a third light emitting diode comprising a first terminal and a second terminal, wherein the first terminal of the third light emitting diode is configured to receive the voltage signal via a third sub-line, and
the second terminal of the third light emitting diode is configured to receive a third current signal, wherein an illumination of the third light emitting diode is determined based on the voltage signal and the third current signal.

2. The pixel circuit of claim 1, wherein the pixel circuit is applied to a display panel.

3. The pixel circuit of claim 1, wherein one of the first terminal and the second terminal is an anode terminal, and another one of the first terminal and the second terminal is a cathode terminal.

4. A pixel circuit comprising:
a first pixel comprising a first light emitting diode, a second light emitting diode, and a third light emitting diode, wherein each of the first light emitting diode, the second light emitting diode, and the third light emitting diode comprises a first terminal and a second terminal;
a first driving circuit coupled to the first terminal of the first light emitting diode, the first terminal of the second light emitting diode, and the first terminal of the third light emitting diode via at least one first line; and
a second driving circuit coupled to the second terminal of the first light emitting diode via a second line, coupled to the second terminal of the second light emitting diode via a third line, and coupled to the second terminal of the third light emitting diode via a fourth line;
wherein the at least one first line comprises a first sub-line, a second sub-line, and a third sub-line, the first driving circuit is coupled to the first terminal of the first light emitting diode via the first sub-line, coupled to the first terminal of the second light emitting diode via the second sub-line, and coupled to the first terminal of the third light emitting diode via the third sub-line, and the first driving circuit sends a voltage signal to the first terminal of the first light emitting diode via the first sub-line, to the first terminal of the second light emitting diode via the second sub-line, and to the first terminal of the third light emitting diode via the third sub-line.

5. The pixel circuit of claim 4, further comprising:
a second pixel comprising a fourth light emitting diode, a fifth light emitting diode, and a sixth light emitting diode, wherein each of the fourth light emitting diode, the fifth light emitting diode, and the sixth light emitting diode comprises a first terminal and a second terminal, wherein the first driving circuit is coupled to the first terminal of the fourth light emitting diode, the first terminal of the fifth light emitting diode, and the first terminal of the sixth light emitting diode via the at least one first line, wherein the second driving circuit is coupled to the second terminal of the fourth light emitting diode via a fifth line, coupled to the second terminal of the fifth light emitting diode via a sixth line, and coupled to the second terminal of the sixth light emitting diode via a seventh line.

6. (canceled)

7. The pixel circuit of claim 4, wherein a same row of a plurality of the first light emitting diodes having a same color light are coupled to the first driving circuit via the first sub-line.

8. The pixel circuit of claim 4, wherein the pixel circuit is applied to a display panel.

9. The pixel circuit of claim 4, wherein one of the first terminal and the second terminal is an anode terminal, and another one of the first terminal and the second terminal is a cathode terminal.

10. A pixel circuit, comprising:
at least one pixel comprising:
a first light emitting diode comprising a first terminal and a second terminal and is corresponding to a first voltage threshold value;
a second light emitting diode comprising a first terminal and a second terminal and is corresponding to a second voltage threshold value; and
a third light emitting diode comprising a first terminal and a second terminal and is corresponding to a third voltage threshold value;
a first driving circuit configured to output a voltage signal to the first terminal of the first light emitting diode via a first sub-line, to the first terminal of the second light emitting diode via a second sub-line, and to the first terminal of the third light emitting diode via a third sub-line; and
a second driving circuit configured to output a first current signal to the second terminal of the first light emitting diode, wherein in response to the voltage signal and the first current signal, a first voltage difference is established across the first terminal of the first light emitting diode and the second terminal of the first light emitting diode, wherein the first voltage difference and the first voltage threshold value are configured to determine an illumination of the first light emitting diode.

11. The pixel circuit of claim 10, wherein the second driving circuit is configured to output a second current signal to the second terminal of the second light emitting diode, wherein in response to the voltage signal and the second current signal, a second voltage difference is established across the first terminal of the second light emitting diode and the second terminal of the second light emitting diode, wherein the second voltage difference and the second voltage threshold value are configured to determine an illumination of the second light emitting diode.

12. (canceled)

13. The pixel circuit of claim 11, wherein:
the second driving circuit is configured to output a third current signal to the second terminal of the third light emitting diode, wherein in response to the voltage signal and the third current signal, a third voltage difference is established across the first terminal of the third light emitting diode and the second terminal of the third light emitting diode, wherein the third voltage difference and the third voltage threshold value are configured to determine an illumination of the third light emitting diode.

14. (canceled)

15. The pixel circuit of claim 13, wherein the second driving circuit transmits the first current signal to the second terminal of the first light emitting diode via a second line, transmits the second current signal to the second terminal of the second light emitting diode via a third line, and transmits the third current signal to the second terminal of the third light emitting diode via a fourth line.

16. The pixel circuit of claim 13, wherein the first voltage threshold value, the second voltage threshold value, and the third voltage threshold value are different from each other.

17. The pixel circuit of claim 13, wherein an illumination change of the first light emitting diode is associated with a first current change of the first light emitting diode, an illumination change of the second light emitting diode is associated with a second current change of the second light emitting diode, and an illumination change of the third light emitting diode is associated with a third current change of the third light emitting diode.

18. The pixel circuit of claim 10, wherein the pixel circuit is applied to a display panel.

19. The pixel circuit of claim 10, wherein one of the first terminal and the second terminal is an anode terminal, and another one of the first terminal and the second terminal is a cathode terminal.
